(19) United States
(12) Patent Application Publication
(10) Pub. No.: US 2024/0058813 A1
(43) Pub. Date: Feb. 22, 2024

(54) FLUID DELIVERY DEVICE WITH PASSIVE PRESSURE EQUILIBRATION

(71) Applicant: Agilent Technologies, Inc., Santa Clara, CA (US)

(72) Inventors: Jonathan Irribarren, Fremont, CA (US); Joel Myerson, Berkeley, CA (US); Bo Curry, Redwood City, CA (US)

(73) Assignees: Agilent Technologies, Inc., Santa Clara, CA (US); Agilent Technologies, Inc., Santa Clara, CA (US)

(21) Appl. No.: 17/891,636

(22) Filed: Aug. 19, 2022

(51) Int. Cl. B01L 3/00

(52) U.S. Cl. CPC B01L 3/502715; B01L 2200/0605; B01L 2200/0621; B01L 2400/0481; B01L 2400/0487; B01L 2400/0638; B01L 2400/0655

(57) ABSTRACT

A fluid delivery device is configured to create a pressure differential across a compartment in which a liquid resides, causing the liquid to flow through the compartment. After a period of time, the fluid delivery device is configured to eliminate the pressure differential and thereby equilibrate the pressure across the compartment, with the use of a pressure equilibration channel that is separate from the compartment. The compartment may contain a packed bed of solid phase particles such as beads. In such case, the pressure differential causes the liquid to flow through the packed bed. The liquid may include chemical reagents or precursors that participate in chemical reactions on or at the solid phase particles. The reactions may relate to chemical synthesis, for example the synthesis of bio-chemicals such as nucleotides.

### TECHNICAL FIELD

The present invention generally relates to the delivery of fluids to flow-through compartments, and particularly to the providing of pressure equalization between the inlet and outlet sides of the compartments. A device implementing such delivery and pressure equalization may be utilized, for example, for performing chemical reactions in the compartments.

### BACKGROUND

Devices such as automated chemistry instruments often require that volumes of liquid, typically ranging from several microliters to several milliliters, be reliably and reproducibly delivered to one or more chemical reaction compartments. One way to address this requirement is to utilize syringes or pumps that rely on positive displacement to meter the volumes of liquid. Positive displacement-based metering can be highly accurate and reproducible. However, as the number of different liquids increases, and in applications involving multiplexed delivery to more than one reaction compartment, multiple metering pumps and/or complex plumbing is needed. Another way is to rely on a pressure-time-volume relationship. For example, a bottle containing a liquid to be delivered may be provided, along with a delivery tube (dip tube) having an inlet end that extends below the surface of the liquid in the bottle and an on/off valve positioned to control fluid flow through the delivery tube. To establish a flow of liquid from the bottle into and through the delivery tube, the headspace in the bottle is pressurized with a gas that is regulated to a constant pressure, and the valve is then opened. In this technique, the volume of liquid that is delivered out from the outlet end of the delivery tube is a function of the size (length, internal diameter) of the delivery tube, the pressure drop across the length of the delivery tube (between the inlet and outlet ends), and the time during which the valve is left open.

In many automated chemistry instruments, the chemistry is performed on a solid phase material contained in a chemical reaction compartment. The solid phase material may be provided as a packed bed of beads composed of, for example, porous silica, controlled pore glass (CPG), or polymer resin. For instruments that have a limited number of reaction compartments, metering pumps may be able to effectively control the delivery of liquid into the bed of solid phase material, or individually calibrated valves may be able to do so via the pressure-time-volume relationship. However, for multiplexed deliveries to multiple reaction compartments, it can be very difficult to deliver the liquid to the solid phase material in the reaction compartments in a controlled and reproducible manner. One known method is to deliver the liquid into the reaction compartment, typically above the solid phase bed, and then rely on a fluid pressure differential to move the liquid into and through the solid phase bed. This step can be very difficult to control, and often results in an under-delivery in which insufficient liquid is delivered to the solid phase material causing the reaction compartment to overflow when multiple deliveries are made, or an over-delivery in which the liquid passes through the solid phase bed too easily and leaves the solid phase bed insufficiently wetted with the liquid.

Therefore, there is an ongoing need for further developments in devices, systems, and methods for delivering fluids to flow-through compartments such as those utilized for performing chemical reactions.

### SUMMARY

To address the foregoing needs, in whole or in part, and/or other needs that may have been observed by persons skilled in the art, the present disclosure provides methods, processes, systems, apparatus, instruments, and/or devices, as described by way of example in implementations set forth below.

According to an aspect of the present disclosure, a fluid delivery device is configured to create a pressure differential across a compartment in which a liquid resides. The pressure differential causes the liquid to flow through the compartment. The pressure differential may be actively created, and maintained for a period of time, by applying positive pressure on an inlet side of the compartment and/or negative pressure (i.e., vacuum) on an outlet side of the compartment. Once the activity maintaining the pressure differential is stopped, the fluid delivery device is configured to rapidly eliminate the pressure differential, i.e. equilibrate the pressure across the compartment, with the use of a pressure equilibration channel that is separate from the compartment. The compartment may contain a packed bed of solid phase elements such as beads. In such case, the pressure differential causes the liquid to flow through the packed bed. The liquid may include chemical reagents or precursors that participate in chemical reactions on or at the solid phase particles, one example being chemical synthesis. A more specific example is the synthesis of bio-chemicals such as polynucleotides.

According to another aspect of the present disclosure, a fluid delivery device includes: a plate comprising a plate opening; a top wall, wherein the top wall and the plate cooperatively enclose a top chamber; a bottom wall, wherein the bottom wall and the plate cooperatively enclose a bottom chamber; a drain port communicating with the bottom chamber; and a pressure equilibration channel comprising a top channel opening communicating with the top chamber and a bottom channel opening communicating with the bottom chamber, wherein: the plate is configured to hold a compartment in the plate opening, such that a compartment inlet of the compartment communicates with the top chamber and a compartment outlet of the compartment communicates with the bottom chamber; and the fluid delivery device defines: a liquid flow path running through the solid phase material and out from the compartment outlet, through the bottom chamber, and into the drain port; and a gas flow path running between the top chamber and the bottom chamber via the pressure equilibration channel.

According to another aspect of the present disclosure, a fluid delivery device includes: a plate comprising a top plate surface, an opposing bottom plate surface, and a plate opening extending from the top plate surface to the bottom plate surface; a top wall, wherein the top wall and the top plate surface cooperatively enclose a top chamber; a bottom wall, wherein the bottom wall and the bottom plate surface cooperatively enclose a bottom chamber; a compartment positioned in the plate opening, the compartment comprising a compartment inlet communicating with the top chamber, a compartment outlet communicating with the bottom chamber, and a solid phase material positioned between the compartment inlet and the compartment outlet; a drain port communicating with the bottom chamber; and a pressure equilibration channel comprising a top channel opening communicating with the top chamber and a bottom channel opening communicating with the bottom chamber, wherein the fluid delivery device defines: a liquid flow path running through the solid phase material and out from the compartment outlet, through the bottom chamber, and into the drain port; and a gas flow path running between the top chamber and the bottom chamber via the pressure equilibration channel.

According to another aspect of the present disclosure, a fluid delivery system includes: a fluid delivery device according to any of the aspects or embodiments disclosed herein; and a pressure regulating device communicating with at least one of the top chamber or the bottom chamber, and configured to create a pressure differential between the top chamber and the bottom chamber.

According to another aspect of the present disclosure, a method for delivering fluids includes: providing a fluid delivery device according to any of the aspects or embodiments disclosed herein; dispensing a liquid into the compartment; operating a pressure regulating device to create a pressure differential between the top chamber and the bottom chamber; continuing to operate the pressure regulating device for a pulse period effective for flowing the liquid along the liquid flow path such that the liquid wets the solid phase material; after the pulse period, ceasing to operate the pressure regulating device; and after the ceasing, eliminating the pressure differential by allowing a gas to flow through the pressure equilibration channel, wherein the liquid ceases to flow through the solid phase material.

According to another embodiment, a non-transitory computer-readable medium includes instructions stored thereon, that when executed on a processor, control or perform one or more of the steps of any of the methods disclosed herein.

According to another embodiment, a fluid delivery system includes the non-transitory computer-readable storage medium.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a cross-sectional elevation view of a known fluid delivery device that has been utilized as an oligonucleotide synthesizer.

FIG. 2 is a cross-sectional elevation view of an example of a fluid delivery device according to an aspect or embodiment of the present disclosure.

FIG. 3 is a cross-sectional elevation view of an example of a compartment according to an aspect or embodiment of the present disclosure.

FIG. 4 is a cross-sectional elevation view of an example of a pressure equilibration channel according to an aspect or embodiment of the present disclosure.

FIG. 5A is a cross-sectional elevation view of another example of a fluid delivery device according to an aspect or embodiment of the present disclosure.

FIG. 5B is a top plan view of the fluid delivery device illustrated in FIG. 5A, with a top wall thereof removed.

FIG. 6A is a cross-sectional elevation view of another example of a fluid delivery device according to an aspect or embodiment of the present disclosure.

FIG. 6B is a top plan view of the fluid delivery device illustrated in FIG. 6A, with a top wall thereof removed.

FIG. 7A is a perspective view of another example of a fluid delivery device according to an aspect or embodiment of the present disclosure.

FIG. 7B is a cross-sectional perspective view of the fluid delivery device illustrated in FIG. 7A.

FIG. 7C is a perspective view of the fluid delivery device illustrated in FIG. 7A, with a top wall thereof removed.

FIG. 7D is a perspective view of a plate of the fluid delivery device illustrated in FIG. 7A.

FIG. 7E is a cross-sectional perspective view of the plate of the fluid delivery device illustrated in FIG. 7A.

FIG. 7F is a top perspective view of the fluid delivery device illustrated in FIG. 7A, with the top wall and the plate removed.

FIG. 7G is a bottom perspective view of the fluid delivery device illustrated in FIG. 7A, with the top wall and the plate removed.

FIG. 8 is a schematic view of an example of a fluid delivery system according to an aspect or embodiment of the present disclosure.

The illustrations in all of the drawing figures are considered to be schematic, unless specifically indicated otherwise.

### DETAILED DESCRIPTION

In this disclosure, all “aspects,” “examples,” and “embodiments” described are considered to be non-limiting and non-exclusive. Accordingly, the fact that a specific “aspect,” “example,” or “embodiment” is explicitly described herein does not exclude other “aspects,” “examples,” and “embodiments” from the scope of the present disclosure even if not explicitly described. In this disclosure, the terms “aspect,” “example,” and “embodiment” are used interchangeably, i.e., are considered to have interchangeable meanings.

In this disclosure, the term “substantially,” “approximately,” or “about,” when modifying a specified numerical value, may be taken to encompass a range of values that include +/−10% of such numerical value.

In this disclosure, the term “fluid” refers to a liquid or a gas, or both a liquid and a gas, as dictated by the context in which the term is used.

In this disclosure, the term “liquid” encompasses a single liquid-phase composition or a mixture or blend of two or more liquid-phase compositions. Examples of a liquid include, but are not limited to, a solution, a suspension, a colloid, or an emulsion. A liquid may contain or carry solid particles (e.g., inorganic particulates, whole biological cells or lysed cell components, etc.) and/or gas or vapor bubbles.

In this disclosure, the term (fluid) “conduit” or (fluid) “line” generally refers to any type of structure enclosing an interior space that defines a repeatable path for fluid to flow from one point (e.g., an inlet of the conduit) to another point (e.g., an outlet of the conduit). A conduit generally includes one or more walls defining a pipe, tube, capillary, channel, or the like. The inner bore or lumen of a conduit may have any shape such as, for example, circular, elliptical, or polygonal. A conduit may be formed by any known technique. A conduit may be formed from a variety of materials such as, for example, fused silica, glasses, ceramics, polymers, and metals. In some embodiments, the material forming the conduit is optically transparent for a purpose such as performing an optics-based measurement or sample analysis, detecting or identifying a substance flowing through the conduit, enabling a user to observe flows and/or internal components in the conduit, etc. Alternatively, the conduit may include an optically transparent window for such purposes.

In this disclosure, the term “(bio)chemical compound” encompasses (non-biological) chemical compounds and biological compounds. Likewise, the term “(bio)chemical reaction” encompasses (non-biological) chemical reactions and biological reactions.

A chemical compound may be, for example, a small molecule or a high molecular-weight molecule (e.g., a polymer, carbohydrate, etc.).

A biological compound may be, for example, a biopolymer. Examples include, but are not limited to, nucleic acids (or polynucleotides). The term “nucleic acid” may refer to a biopolymer of any length, e.g., greater than about 2 bases, greater than about 10 bases, greater than about 100 bases, greater than about 500 bases, greater than 1000 bases, up to about 10,000 or more bases composed of nucleotides, e.g., deoxyribonucleotides or ribonucleotides, which may be produced enzymatically or synthetically, and which can hybridize with naturally occurring nucleic acids in a sequence specific manner analogous to that of two naturally occurring nucleic acids, e.g., can participate in Watson-Crick base pairing interactions. In addition to deoxyribonucleic acid (DNA) and ribonucleic acid (RNA), the term “nucleic acid” (or “polynucleotide”) may encompass peptide nucleic acid (PNA), locked nucleic acid (LNA), and unstructured nucleic acid (UNA). Additional examples include oligonucleotides (or “oligos”). The term “oligonucleotide” may refer to a biopolymer of nucleotides that may be, for example, 10 to 300 or greater nucleotides in length. Oligonucleotides may be synthetic or may be made enzymatically. Oligonucleotides may contain ribonucleotide monomers (i.e., may be oligoribonucleotides) and/or deoxyribonucleotide monomers (i.e., may be oligodeoxyribonucleotides). Oligonucleotides may include modified nucleobases.

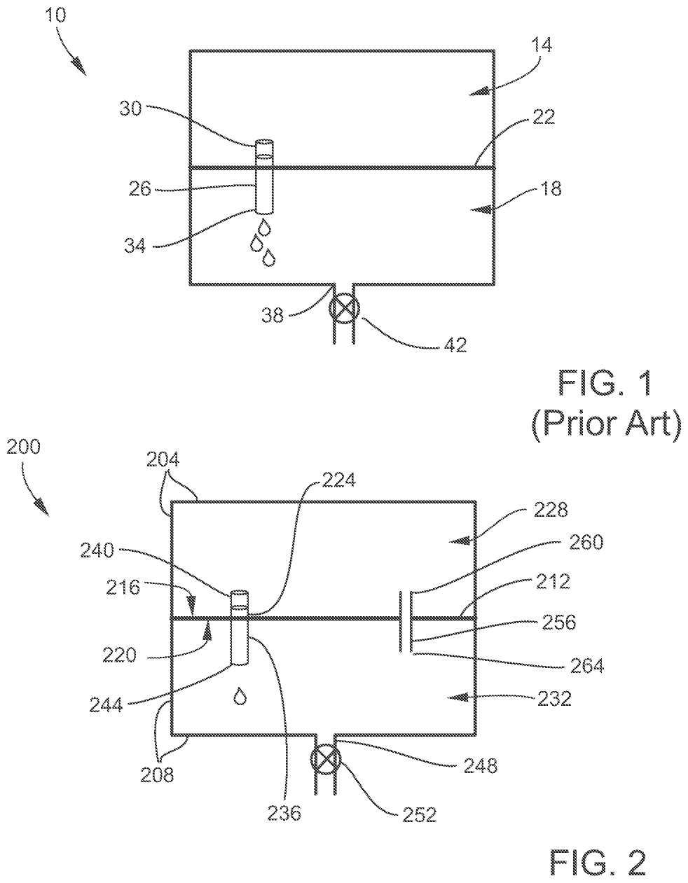

FIG. 1 is a cross-sectional elevation view of a known fluid delivery device 10 that can be utilized as an oligonucleotide synthesizer. The fluid delivery device 10 includes an enclosed top chamber 14 and an enclosed bottom chamber 18 separated by an internal boundary 22. A reaction compartment 26, often referred to as a “column,” is mounted at the boundary 22 such that a compartment inlet 30 of the reaction compartment 26 communicates with the top chamber 14 and a compartment outlet 34 of the reaction compartment 26 communicates with the bottom chamber 18. The reaction compartment 26 contains a packed bed of solid phase material of the type noted above in the Background section of this disclosure. For simplicity, FIG. 1 shows one reaction compartment 26, but multiple reaction compartments 26 may be provided for high-throughput applications. The bottom chamber 18 includes a drain port 38 communicating with a receptacle for collecting liquid (not shown, e.g., a waste container). An on/off drain valve 42 communicates with the drain port 38, i.e., is operatively positioned in the drain line communicating with the drain port 38 so as to control fluid flow through the drain port 38 and associated drain line. Notably, the reaction compartment (or compartments) 26 provides the only fluid communication between the top chamber 14 and the bottom chamber 18.

In use, the fluid pressure in the top chamber 14 and the bottom chamber 18 is initially the same (e.g., around or greater than atmospheric pressure) because the pressure has been equilibrated through the dry reaction compartment(s) 26. Liquid-phase biochemical reagents, or “coupling” reagents (e.g., oligonucleotide precursors), are dispensed into the reaction compartment(s) 26. The solid phase material serves as a substrate on which oligonucleotides can be formed. The coupling reagents are formulated to react with each other in a manner that results in strands of oligonucleotides growing from the solid phase material. For this purpose, the coupling reagents need to flow into the solid phase material and wet the surfaces of the solid phase material sufficiently for the synthesis of the oligonucleotides to occur with an efficient yield. To initiate and drive the liquid flow into the solid phase material, a pressure differential is applied between the top chamber 14 and the bottom chamber 18, and thus between the compartment inlet(s) 30 and the compartment outlet(s) 34. The pressure differential is created by either increasing the pressure in the top chamber 14 or decreasing the pressure in the bottom chamber 18 to thereby cause the liquid to flow through the reaction compartment(s) 26. The pressure in the top chamber 14 may be increased by opening a valve (not shown) and flowing a gas into the top chamber 14. Alternatively, the pressure in the bottom chamber 18 may be decreased by opening the drain valve 42 shown in FIG. 1 to evacuate or release the pressure in the bottom chamber 18. Typical coupling times for synthesizing the oligonucleotides range from one to ten minutes, depending on the details of the chemistry being performed. Excess liquid flows out from the compartment outlet 34 and into the bottom chamber 18 and, with the drain valve 42 in an open state, through the drain port 38 to a desired destination (e.g., waste receptacle).

The coupling reagents can be quite expensive. Hence, it is desirable to utilize only as much of the coupling reagents as is required to obtain an acceptable yield of oligonucleotides, and to prevent the over-deliveries and under-deliveries noted above in the Background section. These considerations create the need for very precise control over the flow of the coupling reagents through the reaction compartment 26, and the need to continuously or iteratively (by multiple delivery and draining steps) flow fresh coupling reagents into the solid phase material for varying lengths of time. The conventional configuration illustrated in FIG. 1 is disadvantageous in that after the coupling reagents are dispensed to the top of the reaction compartment 26, the coupling reagents will not reliably wet the solid phase material after the pressure differential has been applied to initiate the liquid flow through the solid phase material. Once the liquid flow has been initiated, the liquid flow will continue, possibly under the influence of gravity alone, even without the presence of a sustained pressure differential.

Thus, after the pressure differential has been created (whether by increasing the pressure in the top chamber 14 or decreasing the pressure in the bottom chamber 18) to start the drain of liquid through the reaction compartment(s) 26, the pressure differential persists after the valve (e.g., the drain valve 42) is closed and after the liquid starts to flow. In other words, the pressure differential required to initiate the liquid flow will not be equilibrated by the volume of liquid moving onto the solid phase bed(s). This situation leaves a reservoir of excess pressure that will likely cause the reaction compartment(s) 26 to completely drain themselves to relieve the pressure differential. Once the reaction compartment(s) 26 are dry enough that gas can pass through them, only then can the pressures in the top chamber 14 and bottom chamber 18 be equilibrated. If a suitable pressure differential were to be applied that actually would be equilibrated by the volume of liquid moving onto the solid phase bed(s) and no further, it would not be enough pressure to reliably initiate the flow of the liquid.

FIG. 2 is a cross-sectional elevation view of an example of a fluid delivery device 200 according to an aspect or embodiment of the present disclosure. The fluid delivery device 200 includes a top wall 204, a bottom wall 208, and an internal boundary structure referred to herein generally as a plate 212. Any of the top wall 204, bottom wall 208, and plate 212 may have a single-piece construction or may be an assembly of two or more components. The plate 212 generally includes a top plate surface 216, an opposing bottom plate surface 220 (i.e., on a side of the plate 212 opposite to the top plate surface 216), and a plate opening 224 extending from the top plate surface 216 to the bottom plate surface 220 (i.e., through the elevation or thickness of the plate 212). The fluid delivery device 200 further includes a top chamber 228 that is cooperatively enclosed or defined (at least partially) by the top wall 204 and the top plate surface 216, and a bottom chamber 232 that is cooperatively enclosed or defined (at least partially) by the bottom wall 208 and the bottom plate surface 220. The plate opening 224 is thus positioned between, and communicates with, the top chamber 228 and the bottom chamber 232. In other examples, more than one plate opening 224 may be provided, as described below.

The top wall 204, the bottom wall 208 (and optionally the plate 212) may be attached together by any means. In an embodiment, the manner of attachment is sufficient to render the top chamber 228 and the bottom chamber 232 substantially fluid leak-free. In the present context, “substantially” fluid leak-free means that the top chamber 228 and the bottom chamber 232 are capable of maintaining a pressure differential at least for a period of time required by the methods described herein. The fluid tightness may be enhanced by providing appropriate sealing elements at the interfaces of the top wall 204, the bottom wall 208 (and optionally the plate 212), such as elastomeric gaskets, as appreciated by persons skilled in the art. Generally, no limitation is placed on the material composition of the top wall 204, the bottom wall 208, and the plate 212. Various metals or plastics may be utilized, depending on cost and ease of manufacture.

In the context of the present disclosure, the terms “top” and “bottom” (or “upper” and “lower”) are relative to each other and relative to a horizontal plane and a vertical direction. The horizontal plane corresponds to (or is parallel with) any surface on which the fluid delivery device 200 rests or is supported (e.g., tabletop, benchtop, desktop, floor, ground, etc.). The vertical direction is orthogonal to the horizontal plane. The dimension of a structure along the vertical direction may be referred to as the elevation, height, or thickness of that structure. The “top” (or “upper”) part of a structure is located at a higher elevation than the “bottom” part of that structure relative to the vertical direction, and the “bottom” (or “lower”) part is located at a lower elevation than the “top” part relative to the vertical direction. Similarly, for a given structure and related or counterpart structure, the “top” structure is located at a higher elevation than the “bottom” structure relative to the vertical direction, and the “bottom” structure is located at a lower elevation than the “top” structure relative to the vertical direction.

The fluid delivery device 200 further includes a compartment (or column) 236 positioned in the plate opening 224. The compartment 236 includes a compartment inlet 240 communicating with the top chamber 228, a compartment outlet 244 communicating with the bottom chamber 232, and a body having a height (or length) oriented in the vertical direction between the compartment inlet 240 and the compartment outlet 244. As such, the compartment 236 has a fluid flow-through configuration in which, in normal use, a liquid is dispensed through the compartment inlet 240 and thereafter may flow through the compartment 236 and exit the compartment outlet 244. Moreover, a gas may flow through the compartment 236 (if not blocked by a liquid) in either direction (up or down) depending on the pressure differential across the length of the compartment (i.e., between the top chamber 228 and the bottom chamber 232, and thus between the compartment inlet 240 and the compartment outlet 244). In other examples, more than one compartment 236 may be provided, as described below.

Generally, the compartment 236 may be configured as any type of fluid conduit, depending on its application. In some embodiments, the compartment 236 is configured to implement one or more chemical reactions, i.e., the compartment 236 is a chemical reaction compartment. In such cases, the liquid dispensed into the compartment 236 may be a combination of two or more chemical reagents or precursors that are dispensed simultaneously or separately. As one non-exclusive example, the compartment 236 may be utilized to synthesize polynucleotides such as oligonucleotides as described above. In this case, the liquid dispensed into the compartment 236 may be a mixture of two or more coupling reagents having compositions appropriate for the synthesis being implemented. Examples of coupling reagents include, but are not limited to, various phosphoramidites and tetrazole-based activators. To enable or promote the synthesis, the compartment 236 may include a solid phase material that serves as a substrate (or support) for the synthesis of the polynucleotides, as appreciated by persons skilled in the art. Examples of the composition of the solid phase material include, but are not limited to, silica, glass, and various polymer resins (e.g., polystyrene). The solid phase material may be provided as a plurality of solid phase support elements (particles, grains, beads, pellets, etc.) packed together as a solid phase bed. As noted above in the Background section, the solid phase support elements may be beads such as, for example, porous silica, controlled pore glass, or polymer resin. Accordingly, the fluid flow path through the solid phase bed consists of a large number of flow path sections running through the interstices between adjacent solid phase support elements, which maximizes the total surface area available for contact with the dispensed liquid reagents. The shape of the beads is typically spherical, but alternatively may be spheroidal, ellipsoidal or polygonal, or one of the foregoing shapes but somewhat irregular (i.e., not perfect shapes), or highly irregular (e.g., formed by crushing). The characteristic dimension of the beads may be, for example, in a range from 10 μm to 1000 μm, or 50 μm to 100 μm. In the present context, the “characteristic” dimension is an indication of size appropriate for a given or approximate shape, for example, diameter in the case of a sphere, major axis in the case of an ellipsoid, length in the case of a polygon, etc. The pore sizes of the beads may be, for example, in a range from 10 nm to 500 nm, or from 10 nm to 300 nm, or from 10 nm to 200 nm. More generally, the pore size should be pore size should be large enough for the growing polymer chains to be synthesized and small enough to provide enough surface area to synthesize sufficient product. Generally, no limitation is placed on the degree of polydispersity of either the characteristic dimension or the pore sized of the beads.

As an alternative to a packing of solid phase support elements, the solid phase support may be a porous “monolithic support,” which typically has a polymeric or silica based composition, as appreciated by persons skilled in the art. The size of the pores (or interstices) of the monolithic support generally may be in the range specified above regarding bead pores. As a further alternative, the solid phase support may be an “embedded” support, in which porous particles (e.g., controlled pore glass particles) are embedded into a rigid polymer network (e.g., polyethylene or polyethylene based) to form a frit positioned in the compartment 236.

Depending on the application, the outer surfaces of the beads may be functionalized, modified, treated, or coated for a specific purpose. Depending on the application, the chemical reaction performed in the compartment 236 is not limited to the synthesis of biomolecules but may instead involve the synthesis of non-biological polymers or small molecules. Moreover, the chemical reaction performed is not limited to synthesis but instead may involve other types of reactions with (bio)chemical compounds (e.g., de-protecting, cleaving, hybridizing, denaturing, dissociating, conjugating, chelating, complexing, forming of chemical adducts, ionizing, deprotonating, charge exchanging, buffering, pH adjusting, diluting, solvating, emulsifying, labeling, etc.). Furthermore, the solid phase material may be configured for a function other than (bio)chemical reaction. As one non-exclusive example, the solid phase material may be configured as an appropriate sorbent so that the compartment 236 may be utilized to retain synthesized materials, such as for purification.

The fluid delivery device 200 further includes a drain port 248 communicating with the bottom chamber 232. The drain port 248 is typically, but not necessarily, located at a bottom section or surface of the bottom wall 208 to facilitate the collection of excess liquid exiting the compartment outlet 244. For this purpose, the drain port 248 may be placed in fluid communication with a drain line (not shown) that leads to any suitable destination (not shown) for the liquid exiting the bottom chamber 232 via the drain port 248, such as fluid receptacle (container). In some examples, at least a portion of the bottom section or surface of the bottom wall 208 is inclined downwardly toward the drain ports 248 (not specifically shown), which may enhance the draining and collection of liquids exiting the compartments 236. The drain port 248 may also be utilized for fluid pressure regulation in the interior of the fluid delivery device 200 (i.e., in the top chamber 228 and bottom chamber 232). In this case, the fluid delivery device 200 may include a drain valve 252 communicating with the drain port 248. As part of pressurizing the interior of the fluid delivery device 200 in a controlled manner, the drain valve 252 is closed (switched into a closed state). To subsequently create a pressure differential between the top chamber 228 and the bottom chamber 232, the drain valve 252 is opened (switched into an open state), thereby releasing (reducing) the pressure in the bottom chamber 232 relative to the top chamber 228 due to the exiting liquid and gas. Optionally, a vacuum (negative pressure) may be applied at the drain port 248 or another port communicating with the bottom chamber 232. The drain valve 252 may be configured for flow on/off control (i.e., the drain valve 252 is switchable into either the open or closed state, and not into a partially open/closed state). Alternatively, the drain valve 252 may be configured for both on/off flow control and variable flow rate control (i.e., adjustable to intermediate states between the fully open and fully closed states). Variable flow rate control may be useful for adjusting the pressure differential applied.

In one example, a vacuum pump (not shown) also may be positioned in the drain line to enhance the application and control of the pressure differential.

The fluid delivery device 200 further includes one or more pressure equilibration channels 256. The pressure equilibration channel 256 is a flow restricted channel that fluidly connects the top chamber 228 and the bottom chamber 232. Accordingly, the pressure equilibration channel 256 includes a top channel opening 260 communicating with the top chamber 228, a bottom channel opening 264 communicating with the bottom chamber 232, and body defining a lumen (inside bore) of a predetermined size (length and inside diameter) extending between the top channel opening 260 and the bottom channel opening 264. The pressure equilibration channel 256 may be positioned at the plate 212 and at some distance from the compartment 236. The pressure equilibration channel 256 may include a bore extending through a section of the plate 212, or a tube extending from and/or through a bore or opening of the plate 212, or a tube extending from the top wall 204 to the bottom wall 208 but positioned outside of the plate 212. Accordingly, the lumen may be defined by a bore, a tube, or a combination of both.

The pressure equilibration channel 256 is a passive device that has no moving parts and does not require any type of active control. The lumen of the pressure equilibration channel 256 is typically open, or unobstructed, in the sense that no additional components or features need to be provided in the lumen (for example, in comparison to the compartment 236 that may include a solid phase material as described above). The pressure equilibration channel 256 is flow restricted in the sense that it provides limited gas conductance in comparison to the drain port 248. That is, the pressure equilibration channel 256 is sized to provide a greater flow restriction (or flow resistance) to gas flow than the drain port 248. As one non-exclusive example, the inside diameter of the pressure equilibration channel 256 may be in a range from 1/32 inch (about 0.8 mm) to ⅛ inch (about 3.2 mm), while the inside diameter of the drain port 248 may be in a range from ¼ inch (6.35 mm) to ½ inch (12.7 mm). The flow restriction of the pressure equilibration channel 256 may be increased by decreasing its inside diameter and/or increasing its length.

The pressure equilibration channel 256 provides a pathway for gas conductance between the top chamber 228 and the bottom chamber 232. Gas will flow through the pressure equilibration channel 256 in the presence of a pressure differential between the top chamber 228 and the bottom chamber 232, and thus between the top channel opening 260 and the bottom channel opening 264 (across the length of the pressure equilibration channel 256). Typically, a pressure differential is applied such that the pressure in the top chamber 228 is higher than the pressure in the bottom chamber 232, in which case gas will flow downward through the pressure equilibration channel 256 from the top chamber 228 to the bottom chamber 232. Even after such pressure differential is no longer actively applied, the gas will continue to flow downward through the pressure equilibration channel 256 until the pressures in the top chamber 228 and the bottom chamber 232 are equilibrated (equalized).

The pressure equilibration channel 256 is advantageous in that it may allow a greater pressure differential to be applied, and enable the pressures to subsequently be equilibrated more rapidly (enable the pressure differential to be eliminated), than the conventional situation in which the pressure equilibration channel 256 is not provided. The flow restriction presented by the pressure equilibration channel 256 is set such that the fluid flow (e.g., volumetric flow rate) through the drain port 248 (and open drain valve 252) is greater than the fluid flow through the pressure equilibration channel 256. This configuration allows for the desired higher pressure differential between the top chamber 228 and the bottom chamber 232 that is needed to reliably initiate the liquid flow through the compartment 236 (and the solid phase material therein). When the drain valve 252 is thereafter closed (or the pressure differential is otherwise no longer actively applied), the pressures in the top chamber 228 and the bottom chamber 232 rapidly equilibrate via the pressure equilibration channel 256, and consequently the liquid flow through the compartment 236 stops. Hence, unlike a conventional fluid delivery device such as described above in conjunction with FIG. 1, the pressure in the fluid delivery device 200 is equilibrated without requiring that all of the liquid pass entirely through the compartment 236, i.e., without requiring the compartment 236 be dry.

Moreover, a larger pressure differential may be applied without draining the compartment 26 completely, which is particularly useful when draining multiple compartments 236. Due to the variability among multiple compartments 236, some compartments 236 may require a larger pressure differential to initiate the liquid flow. By applying a short-lived and large pressure differential, liquid may be delivered to multiple compartments 236 more reliably.

Another advantage of the pressure equilibration channel 256 is that it may dramatically decrease the effect of gas pressure leaks in the bottom chamber 232. Such leaks may occur in the bottom chamber 232 itself or in any valves (e.g., the drain valve 252) communicating with the bottom chamber 232. Without the pressure equilibration channel 256, such leaks will result in a pressure differential that can be relieved only by equilibration through the compartment 236, which in turn will result in either an unintentional delivery or an over-delivery of any liquid present in the column. On the other hand, the pressure equilibration channel 256 compensates for any such leaks by equilibration through the pressure equilibration channel 256, thereby preventing the development of a pressure differential due to the leaks and thus preventing an unintentional delivery or over-delivery of liquid. Moreover, the pressure equilibration channel 256 reduces the risk of backflow through the compartment 236 in the event of an upward directed pressure differential, such as if the top chamber 228 is opened while the bottom chamber 232 is (still) pressurized. Furthermore, because the pressure equilibration channel 256 is a passive device, it does not require any electronics or control system for its operation. Hence, the pressure equilibration channel 256 does not appreciably contribute to the complexity and cost of the fluid delivery device 200, and avoids any problems or challenges that may occur if components associated with electronics or a control system were to be installed in the same enclosed space where liquid reagents are added and chemical reactions are carried out.

As evident from the foregoing, the fluid delivery device 200 defines or establishes at least two fluid flow paths: The first is a liquid flow path that runs through the compartment 236 (and through the solid phase material therein, if provided) and out from the compartment outlet 244, through the interior space of the bottom chamber 232, and into the drain port 248 (and through the drain valve 252 if opened. The second is a gas flow path that runs between the top chamber 228 and the bottom chamber 232 via the pressure equilibration channel 256, typically in the direction from the top chamber 228 to the bottom chamber 232, but more generally in a direction dependent on which chamber is at a higher pressure than the other chamber.

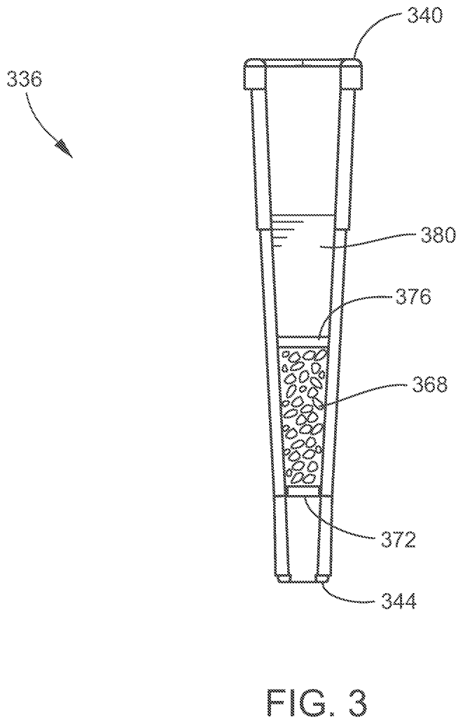

FIG. 3 is a cross-sectional elevation view of another example of a compartment 336 according to an aspect or embodiment of the present disclosure. The compartment 336 includes a compartment inlet 340, a compartment outlet 344, and a solid phase material 368 positioned between the compartment inlet 340 and the compartment outlet 344. In this example, the body of the compartment 336 has a tapered shape similar to a pipette tip, such that the inside diameter of the compartment 336 is at a maximum at the compartment inlet 340 and reduces in the direction of the compartment outlet 344. Also in this example, the solid phase material 368 is a packed bed of solid phase support elements (e.g., beads) as described above. The compartment 336 typically includes a (first) frit 372 (e.g., a porous or perforated glass or polymer disk) on which the solid phase material 368 is retained in a fixed position in the compartment 336. If needed, an additional (second) frit 376 may be inserted onto the top of the solid phase material 368 to maintain a close, uniform packing and to prevent loss of solid phase material 368 due to the occurrence of back pressure.

FIG. 3 also depicts a volume of liquid 380 having been dispensed into the compartment 336. Initially, if the liquid 380 is dispensed while no pressure differential exists across the length of the compartment 336, the liquid 380 will largely remain separated from the underlying solid phase material 368 due to the flow resistance presented by the solid phase material 368, although the liquid 380 may wet an upper portion of the solid phase material 368 to some degree due to gravitational force and wicking. Subsequently, upon application of a pressure differential as described herein (with the pressure being higher at the compartment inlet 340 than at the compartment outlet 344), the liquid 380 will start to drain through, and wet the surfaces of, the solid phase material 368, whereby the pertinent chemical reaction(s) are carried out.

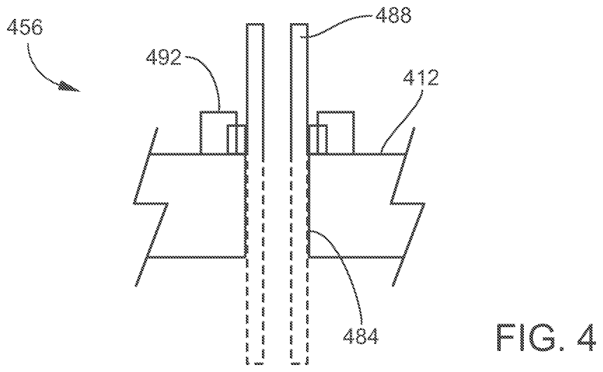

FIG. 4 is a cross-sectional elevation view of an example of a pressure equilibration channel 456 according to an aspect or embodiment of the present disclosure. The pressure equilibration channel 456 may be formed by a bore 484 that passes through an internal boundary structure of the associated fluid delivery device, such as a plate 412 as described above. Alternatively, and in the illustrated example, the pressure equilibration channel 456 is formed by a tube 488 that may be securely mounted to the plate 412 by any suitable mounting component(s) 492 (e.g., a tube fitting). For example, the mounting component(s) 492 may include an engagement section configured to attach to or mate with a complementary engagement section of the plate 412. The engagement sections may have any configuration suitable for making robust fluidic couplings, such as screw-type threads, Luer-type fittings, etc. The tube 488 may be mounted into abutting contact with one side of the plate 412 and extend upwardly or downwardly from the plate 412 in alignment with the bore 484, in which case the pressure equilibration channel 456 is formed by the combination of the bore 484 and the tube 488. Alternatively, the tube 488 may extend into, or additionally pass completely through, the bore 484, as indicated by dashed lines in FIG. 4. In either case, the tube 488 renders adjustable the degree of flow restriction provided by the pressure equilibration channel 456, by adjusting the size of the lumen of the tube 488 as described above. For example, the flow restriction may be adjusted by replacing the existing tube 488 with a new tube 488 having a different length and/or inside diameter than the previous tube 488.

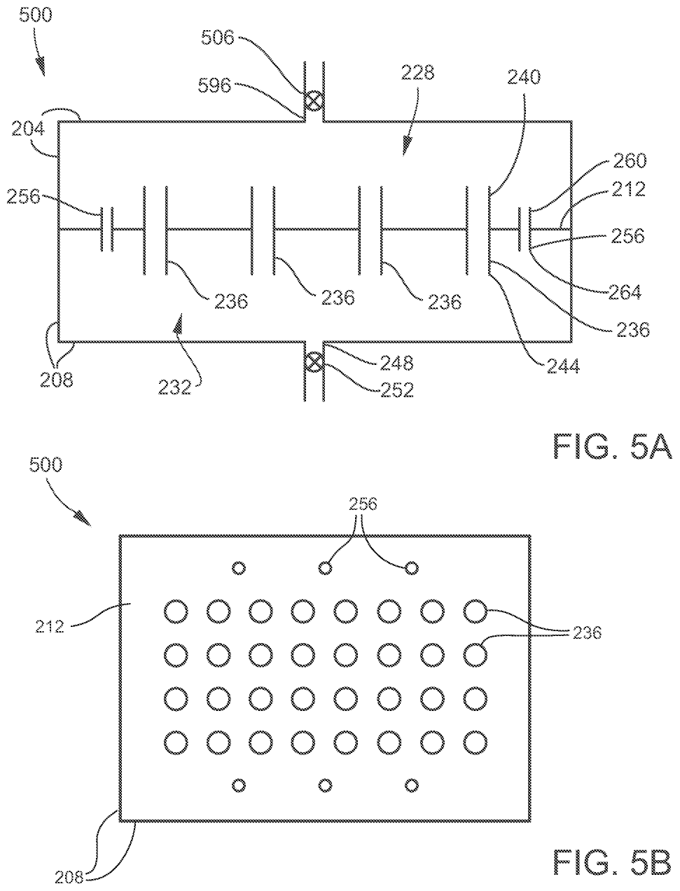

FIG. 5A is a cross-sectional elevation view of another example of a fluid delivery device 500 according to an aspect or embodiment of the present disclosure. FIG. 5B is a top plan view of the fluid delivery device 500, with the top wall 204 (FIG. 2) removed. The fluid delivery device 500 includes multiple compartments 236 (or 336). As illustrated, the compartments 236 typically are arranged as a two-dimensional array, i.e., n rows and m columns. In the present example, the array includes four rows and eight columns of compartments 23, but may generally include any number of compartments 236 arranged in any number of rows and columns. For example, the array may be a 2:3 rectangular array typical of multi-well plate formats, such as a 96-compartment array (8 rows and 12 columns), a 384-compartment array, or a 1536-compartment array. The compartments 236 typically are spaced from each other at uniform distances along the direction of both the rows and the columns. The distance between adjacent compartments 236 (e.g., center-to-center distance of the compartment inlets 240) may be referred to as the “pitch” of the array. In one example, the pitch is in accordance with known standards such as the American National Standards Institute/Society for Laboratory Automation and Screening (ANSI/SLAS) standards for multi-well plates current at the time of filing the present disclosure. For example, the pitch may be as specified by ANSI/SLAS 4-2004 (R2012): Microplates—Well Positions. Thus, the pitch may be 9.0 mm+/−0.7 mm for an array of 96 compartments 236, 4.5 mm+/−0.7 mm for an array of 384 compartments 236, or 2.25 mm+/−0.5 mm for an array of 1536 compartments 236. The pitch may be selected in this manner, for example, to closely match the pitch of an array of pipette tips that are part of a liquid dispensing device utilized to dispense liquids into the compartments 236, thereby ensuring alignment with the pipette tips. In a more general example, the pitch may be in a range from 2 mm to 50 mm. Alternatively, the distance between adjacent compartments 236 may be non-uniformly spaced from each other (i.e., the pitch may be uneven).

In this example, the plate openings of the plate 212 are sized and positioned (arranged) such that, when the compartments 236 are positioned in the plate openings, the compartments 236 (or at least the compartment inlets 240) are spaced from each other at a desired distance such as one of the pitch values specified above.

As also illustrated, the fluid delivery device 500 may also include multiple pressure equilibration channels 256 (or 456), which have been arbitrarily located in FIGS. 5A and 5B. Multiple pressure equilibration channels 256 may be desirable, for example, to ensure uniform pressure equilibration across the horizontal area spanned by the top chamber 228 and bottom chamber 232. Multiple pressure equilibration channels 256 may also be utilized as another means for adjusting flow resistance, for example by plugging one or more of the pressure equilibration channels.

Accordingly, in the present example, the fluid delivery device 500 defines or establishes multiple liquid flow paths that run from the respective compartments 236, through the bottom chamber 232, and to the drain port 248, and multiple gas flow paths that run through the respective pressure equilibration channels 256. More than one drain port 248 may be provided.

FIGS. 5A and 5B also illustrate an embodiment in which the fluid delivery device 500 includes a gas inlet port 596 communicating with the top chamber 228. The gas inlet port 596 may be connected to a gas supply line (not shown) and utilized to pressurize the top chamber 228. A gas inlet valve 506 (configured for on/off flow control, or additionally variable flow rate control) communicating with the gas inlet port 596 may be provided to control the gas flow into the top chamber 228. In this embodiment, the pressure differential utilized to initiate liquid flow in the compartments 236 may be applied by closing the drain valve 252, opening the gas inlet valve 506, and flowing a gas from a pressurized gas source (e.g., a pressurized gas tank, a gas pump, etc.) through the gas inlet port 596 into the top chamber 228. As an example, the gas may be a suitably chemically inert gas such as helium, nitrogen, argon, etc. The gas inlet port 596 and gas inlet valve 506 may also be provided as an alternative embodiment of the fluid delivery device 200 described above and illustrated in FIG. 2, or any other fluid delivery device disclosed herein.

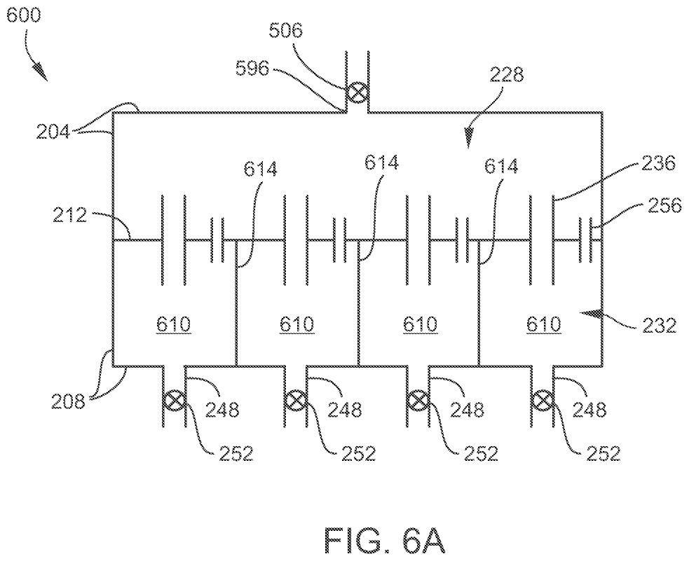

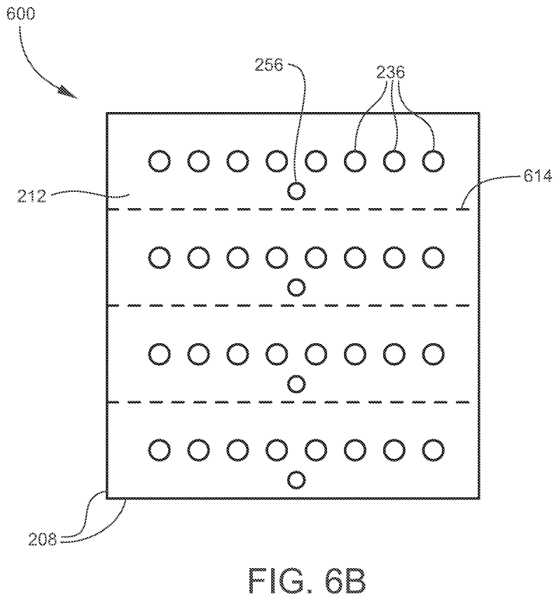

FIG. 6A is a cross-sectional elevation view of another example of a fluid delivery device 600 according to an aspect or embodiment of the present disclosure. FIG. 6B is a top plan view of the fluid delivery device 600, with the top wall 204 (FIG. 2) removed. The fluid delivery device 600 includes multiple compartments 236 and multiple pressure equilibration channels 256. The bottom wall 208 is configured to structurally partition the bottom chamber 232 into multiple bottom sub-chambers (or drain manifolds) 610 that are physically separate from each other. For example, the sub-chambers 610 may be separated by partition sections 614 of the bottom wall 208. The compartments 236 are arranged in a two-dimensional array such as shown in FIG. 5B, and are divided into groups of compartments 236 (compartment groups). For example, in FIG. 5B, the four rows of compartments 236 may correspond to four compartment groups. As illustrated in FIG. 6, each sub-chamber 610 separately communicates with a respective one of the compartment groups, and also with one or more of the pressure equilibration channels 256. In addition, the fluid delivery device 600 includes multiple drain ports 248, each separately communicating with a respective one of the sub-chambers 610. This configuration may be useful for enhancing control over the application of pressure differentials and subsequent pressure equilibration, by dividing the array of compartments 236 into groups consisting of a smaller number of compartments 236. A separate drain valve 252 may be provided for each drain port 248. Alternatively, the separate drain lines leading from the drain ports 248 may merge into a common drain line at which a single drain valve 252 is positioned.

In the present example, the arrangement of compartment groups is realized by the plate openings of the plate 212 likewise being divided into groups of plate openings, with each sub-chamber 610 separately communicating with a respective one of the plate opening groups.

Accordingly, in the present example, the fluid delivery device 600 defines or establishes multiple liquid flow paths that run from the respective compartments 236, through the corresponding sub-chambers 610, and to the corresponding drain ports 248, and multiple gas flow paths that run through the respective pressure equilibration channels 256 between the top chamber 228 and respective sub-chambers 610.

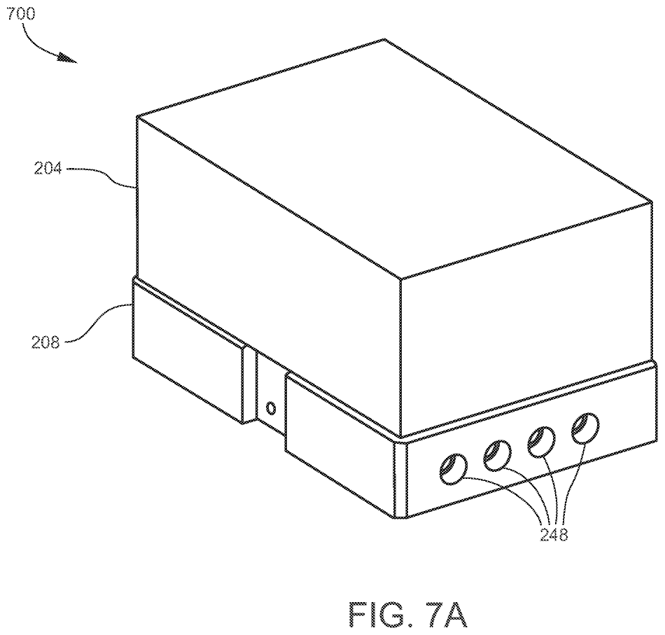

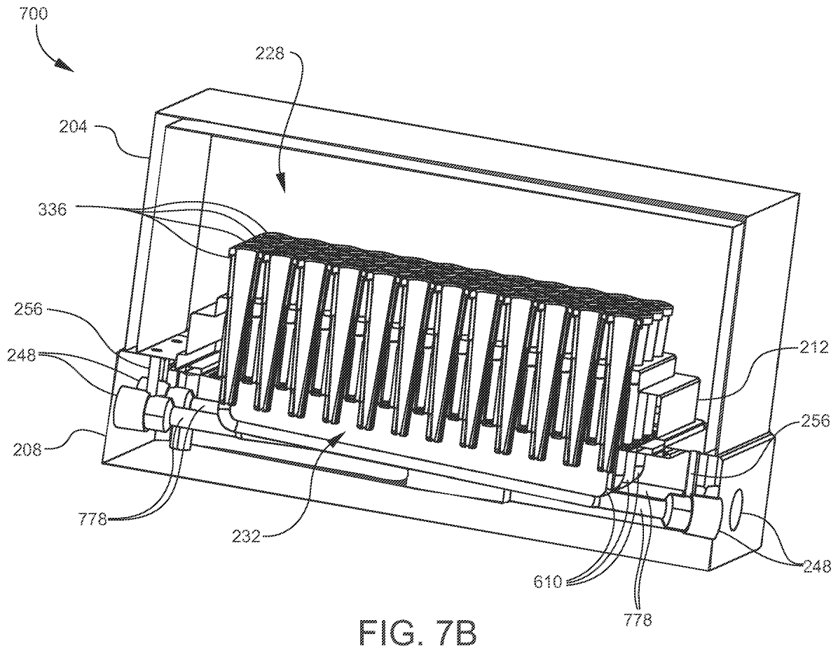

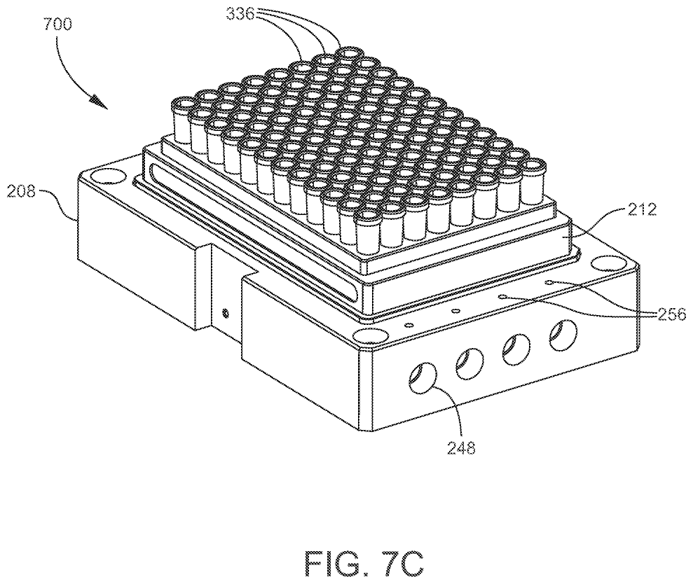

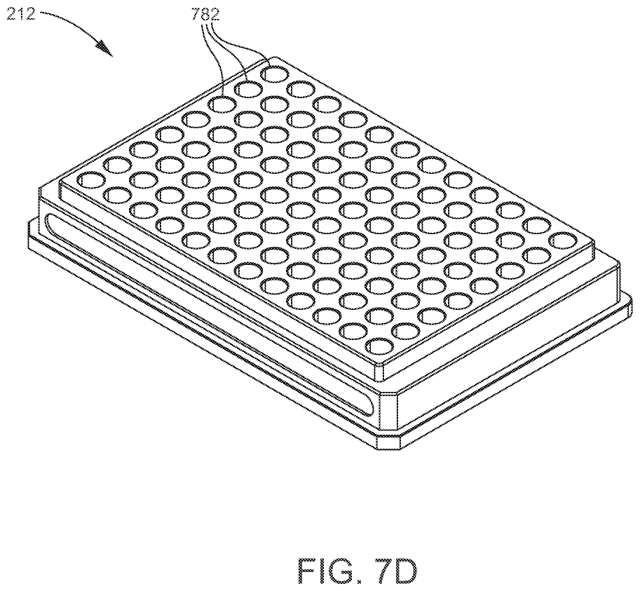

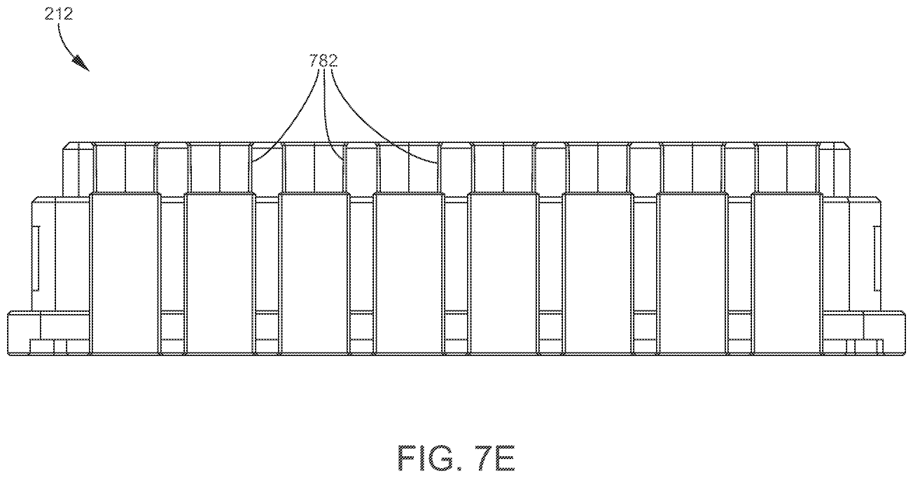

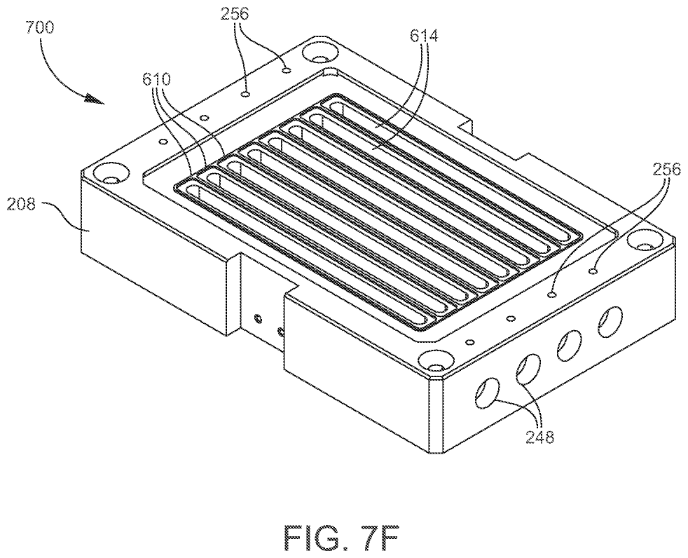

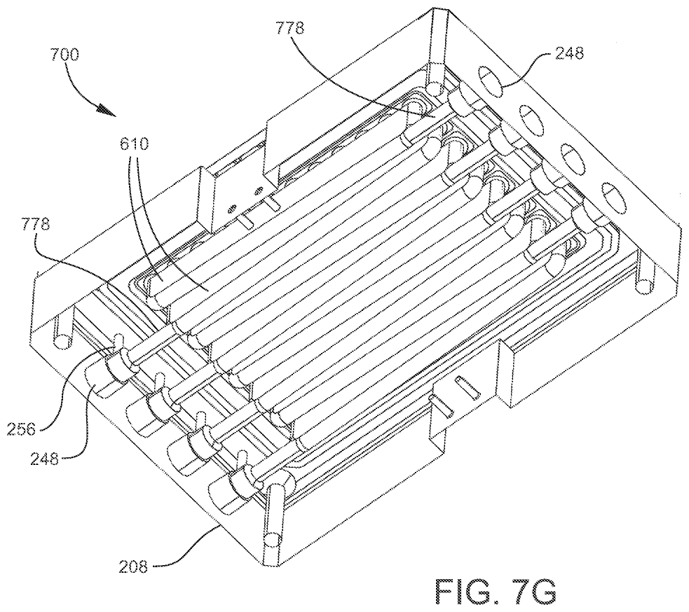

FIGS. 7A-7G illustrate FIG. 7A another example of a fluid delivery device 700 according to an aspect or embodiment of the present disclosure. FIG. 7A is a perspective view of the fluid delivery device 700. FIG. 7B is a cross-sectional perspective view of the fluid delivery device 700. In this example, the compartments 336 are the same as or similar to those described above and illustrated in FIG. 3, but alternatively may have a different configuration. In this example, the plate 212 has a three-dimensional geometry, i.e., does not necessarily have a flat planar geometry such as schematically depicted in other drawing figures. The plate 212 may be considered to be, or include, a compartment holder.

Similar to the fluid delivery device 600 described above and illustrated in FIGS. 6A and 6B, the bottom chamber 232 is divided into multiple (e.g., eight) bottom sub-chambers (or drain manifolds) 610. The walls defining the individual sub-chambers 610 (e.g., the partition sections 614 shown in FIG. 7F) may be considered to be parts of the bottom wall 208. Each row of compartments 336 extends into a corresponding sub-chamber 610. As shown in FIG. 7B, multiple drain passages 778 respectively interconnect the sub-chambers 610 with corresponding drain ports 248, The drain passages 778 may be considered as being part of the sub-chambers 610 or the drain ports 248. In this example, the drain passages 778 communicate with corresponding pressure equilibration channels 256. Thus, each pressure equilibration channel 256 may be considered as communicating with a corresponding sub-chamber 610 and/or drain port 248. As also shown in FIG. 7B (see also FIGS. 7F and 7G), the bottom surfaces of the sub-chambers 610 are inclined downwardly toward the drain ports 248, which may enhance the draining and collection of liquids exiting the compartments 336 as noted above.

FIG. 7C is a perspective view of the fluid delivery device 700, with the top wall 204 (FIG. 7A) removed. In this example, 96 compartments 336 are provided as an array of eight rows and twelve columns. Accordingly, eight sub-chambers 610 (FIGS. 7B, 7F and 7G) are provided, with twelve compartments 336 draining into each sub-chamber 610.

FIG. 7D is a perspective view of the plate 212, and FIG. 7E is a cross-sectional perspective view of the plate 212. The plate 212 includes an array of (e.g., 96) through-holes 782 that extend from the top surface to the bottom surface of the plate 212. The through-holes 782 are configured to hold corresponding compartments 336 such that the compartments 336 are in open communication with the top chamber 228 and the bottom chamber 232 (FIG. 7A), as described above. In this example, the through-holes 782 are uniformly spaced from each other so that the compartments 336, when mounted, are likewise uniformly spaced from each other, which may result in a uniform pitch as described above.

FIG. 7F is a perspective view of the fluid delivery device 700, with the top wall 204 (FIG. 7A) and the plate 212 (FIGS. 7D and 7E) removed. FIG. 7G is a bottom perspective view of the fluid delivery device 700, with the top wall 204 and plate 212 removed. FIGS. 7F and 7G show eight distinct sub-chambers 610, which communicate with eight corresponding pressure equilibration channels 256.

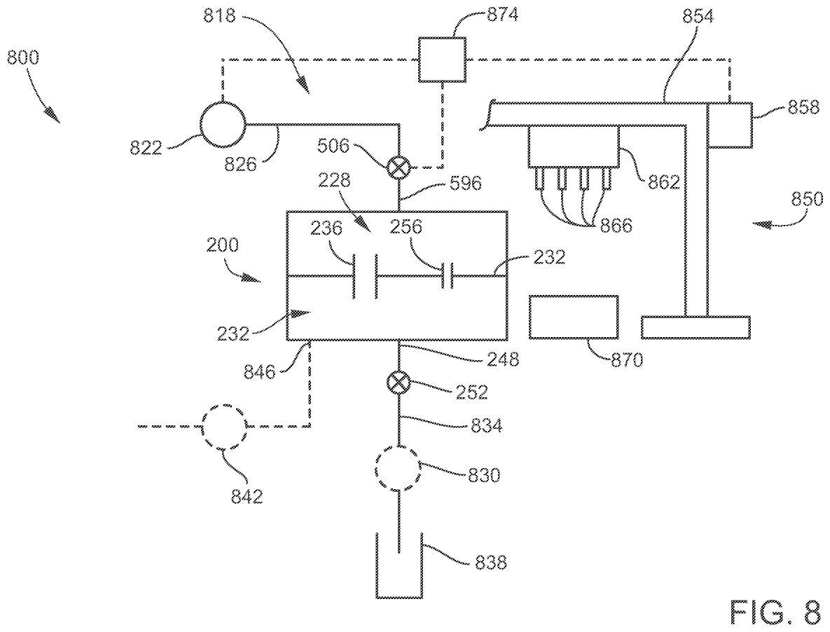

FIG. 8 is a schematic view of an example of a fluid delivery system 800 according to an aspect or embodiment of the present disclosure. The fluid delivery system 800 includes a fluid delivery device according to any of the embodiments or examples disclosed herein (e.g., the fluid delivery device 200, 500, 600, or 700, illustrated in FIGS. 2, 5A and 5B, 6A and 6B, or 7A-7G, respectively). The fluid delivery system 800 also includes a pressure regulating device 818 communicating with the top chamber 228 of the fluid delivery device 200. Generally, the pressure regulating device 818 may be any component or combination of components configured to control pressure in the fluid delivery device 200 and apply a pressure differential between the top chamber 228 and the bottom chamber 232 in the manner described herein. In the present example, the pressure regulating device 818 includes the gas inlet valve 506 described above, and a pressurized gas source 822 communicating with the gas inlet valve 506 and the gas inlet port 596 via a gas supply line 826. The pressurized gas source 822 may include, for example, a pressurized gas reservoir (e.g., tank) or a gas pump.

Alternatively or additionally, the pressurized gas source 822 may include a fluid pump 830 communicating with the drain valve 252 and the drain port 248 via a drain line 834 that leads to a liquid collection receptacle 838. Alternatively or additionally, the pressurized gas source 822 may include a gas pump (or vacuum pump) 842 that communicates with a gas outlet port 846, which communicates with the bottom chamber 232 separately from the drain port 248.

The fluid delivery system 800 may be configured for dispensing liquids into the compartments 236 manually and/or automatically (or robotically). For example, a user may open the top chamber 232 (e.g., by removing the top wall 204, see FIG. 2, or opening a section of the top wall 204 such as a lid or door) and dispense liquids into the compartment(s) 236 using a manual pipette or other liquid dispensing device. Alternatively, the fluid delivery system 800 may include, or operate in conjunction with, an automated liquid dispensing system 850. In the illustrated example, the automated liquid dispensing system 850 includes a robot, which generally may be of the type commonly provided in lab automation tools as appreciated by persons skilled in the art. Thus, for example, the robot may include one or more movable stages 854 driven by one or more motors 858 (e.g., precision, bi-directional stepper motors) via appropriate transmission linkages (e.g., belts, chains, screws, worms, etc.) to drive and control the movement of an end effector, which in this example is a pipettor head 862. The pipettor head 862 includes one or more (e.g., a two-dimensional array) pipette tips 866. The pipettor head 862 is movable along two or three axes (X-Y-Z) as needed for dispensing liquids into the compartments 236.

As one example, the pipettor head 862 is lowered toward a liquid source 870 (e.g., a reservoir) to immerse the pipette tip(s) 866 in the liquid supplied by the liquid source 870. A controlled aliquot or aliquots of the liquid are then aspirated into the pipette tip(s) 866. The pipettor head 862 is then raised, moved to a position above the (opened) top chamber 228, and lowered toward the compartment(s) 236 far enough to avoid splashing or spilling during the dispensing step (e.g., the pipette tip(s) 866 may extend through the compartment inlet(s) 240, see FIG. 2). The aliquot(s) of liquid(s) are then dispensed from the pipette tip(s) 866 into the compartment(s) 236. Alternatively, the liquid source 870 may represent the compartment(s) 236 (e.g., a station that temporarily holds the compartment(s) 236), and the movable end effector may be or include a gripping device instead of the illustrated pipettor head 862. In this case, the robot would be configured to securely grasp the compartment(s) 236 and transport them from the liquid source 870 to the plate 212. As another alternative, the liquid source 870 may represent the compartment(s) 236 and at least a portion of the plate 212 that is configured as a compartment holder (e.g., similar to a vial rack, or a multi-well plate with through-holes instead of well). In this case, the robot would be configured to securely grasp the compartment holder, with the compartment(s) 236 supported thereby, and transport the compartment holder to the proper mounting position in the fluid delivery device 200. Such robots may also be configured to remove the compartment(s) 236 and/or the compartment holder after use. In all such cases, as part of the dispensing process, the top chamber 228 may be opened manually or automatically. In the latter case, as one example, a separate robot with a movable gripping device as an end effector may be configured to securely grasp and remove the top wall 204 or open an openable section of the top wall 204, and may further be configured to subsequently reinstall the top wall 204 or close an openable section of the top wall 204.

The fluid delivery system 800 may further include, or electrically or electromagnetically communicate by one or more wired or wireless communication links, an electronics-based system controller 874 (or controller, control unit, control module, computing device, etc.). The system controller 874 may be configured to control the operation of one or more of the active components of the fluid delivery device 200 and/or fluid delivery system 800, such as the drain valve 252, components of the pressure regulating device 818, liquid dispensing system 850 and/or other robots or automated devices, etc., as partially depicted by a few dashed lines in FIG. 8. For these purposes, the system controller 874 generally may include any combination of hardware or firmware components (e.g., microelectronic chips, integrated circuits (ICs), and solid state circuit components (e.g., resistors, capacitors, inductors, transformers, switches, etc.), e.g., mounted on rigid circuit boards or flexible circuit substrates), including one or more electronics-based processors and memories, or additionally software, suitable for implementing control and monitoring of the active components, as appreciated by persons skilled in the art. The system controller 874 may be configured to implement one or more of the control functions needed for operating the fluid delivery device 200 and/or fluid delivery system 800, and/or may communicate with a more remotely positioned system controller that implements one or more other control functions not directly or fully controlled by the illustrated local system controller 874. The system controller 874 also may be configured to monitor (e.g., by receiving feedback signals) one or more sensors that may be provided such as, for example, pressure sensors, fluid flow sensors, temperature sensors, motion encoders, positional sensors (e.g., encoders, photocells, etc.), etc. The system controller 874 also may be configured to perform one or more steps of any of the methods disclosed herein. The system controller 874 may include a non-transitory (or tangible) computer-readable medium that includes non-transitory instructions for performing method steps and/or other functions. One or more of the communication links may be rigid or flexible electrical circuits, with wiring configured as busses, ribbons, cables, or the like. Alternatively or additionally, one or more of the communication links may be wireless (e.g., links that involve the transmission and receiving of radio frequency (RF) signals propagating through the air).

A non-exclusive example of a method or process for delivering fluids will now be described. The method may be implemented with the use of a fluid delivery device according to any of the embodiments or examples disclosed herein (e.g., the fluid delivery device 200, 500, 600, or 700, illustrated in FIGS. 2, 5A and 5B, 6A and 6B, or 7A-7G, respectively), in conjunction with an associated fluid delivery system such as the fluid delivery system 800 described above and illustrated in FIG. 8. The top chamber 228 is opened, and one or more liquids are dispensed into one or more compartments 236 provided with or installed in the fluid delivery device 200. The top chamber 228 is then closed. With the drain port(s) 248 also closed, the pressure regulating device 818 is operated to create (or generate) a pressure differential between the top chamber 228 and the bottom chamber 232, by performing any of the pertinent techniques described herein. The pressure regulating device 818 continues to be operated to actively maintain the pressure differential for a duration of time referred to herein as a pulse period. Generally, the duration of the pulse period is selected to be at least long enough to be effective for flowing the liquid(s) along the liquid flow path(s) such that the dispensed liquid(s) 380 (FIG. 3) substantially wet the entire solid phase material(s) 368 (FIG. 3) positioned in the compartment(s) 236. As one example, the entire solid phase material 368 in a given compartment 236 is substantially wetted when at least 75% of the total outside surface area of the solid phase material 368 is wetted. The optimal duration of the pulse period may depend on several factors such as, for example, the magnitude of the applied pressure differential, the flow resistance imposed by the solid phase material 368, the total volume occupied by the solid phase material 368, the total outside surface area of the solid phase material 368, the viscosity of the dispensed liquid 380, the total volume of the dispensed liquid 380, etc. As one example, the magnitude of the applied pressure differential be in a range from 0.1 psi (about 0.69 kPa) to 50 psi (about 345 kPa), or from 0.1 psi to 10 psi (about 69 kPa). As one example, the pulse period may be in a range from 0.1 s to 1000 s.

Subsequently, at the end of the pulse period, the operation of the pressure regulating device 818 is stopped so as to no longer actively apply the pressure differential, by performing any of the pertinent techniques described herein. The pressure differential is then eliminated or relieved by allowing a gas to flow through the pressure equilibration channel(s) 256. As one example, the duration of time required to fully equilibrate the pressures in the top chamber 228 and the bottom chamber 232 may be in a range from 0.1 s to 1000 s. Consequently, removal of the actively applied pressure differential and subsequent rapid pressure equilibration causes the liquid(s) to stop flowing downward through the solid phase material(s) 368. During the performance of this method, any liquid(s) exiting the compartment(s) 236 are collected at the drain port(s) 248. If the volume of the liquid 380 permits, multiple additions of the liquid 380 may be performed by subjecting the fluid delivery device 200 to another pulse period of the same or a different duration. In this way, the solid phase material 368 can be exposed to fresh reagent without having to deliver more fluid to the compartment 236.

In some examples, the dispensed liquid(s) 380 and the solid phase material(s) 368 are configured to promote (or induce, carry out, perform, conduct, etc.) one or more (bio)chemical reactions on or at the solid phase material(s) 368, as described herein. The duration of time required to complete these types of (bio)chemical reactions is referred to herein as a reaction period. Typically, but not necessarily, these types of (bio)chemical reactions begin to occur as soon as the dispensed liquid(s) 380 begin to wet the solid phase material(s) 368. In this case, the start of the reaction period may coincide (or substantially coincide) with the start of the pulse period. Typically, but not necessarily, the duration of the reaction period is longer than the pulse period. In other words, the (bio)chemical reaction(s) may proceed after removing the actively applied pressure differential and thus after liquid flow through the compartment(s) 236 has ceased. Moreover, the (bio)chemical reaction(s) (i.e., the reaction period) may end either while pressure equilibration is still ongoing or after pressure equilibration has been completed. In all such cases, after the end of the reaction period, the top chamber 228 may be reopened, and the synthesized (bio)chemicals (or products of another type of (bio)chemical reaction) may then be subjected to further chemical reactions in order to continue or complete the synthesis of the (bio)chemical, or be subjected to further processing or analysis as called for by the application being implemented.

### EXEMPLARY EMBODIMENTS

Exemplary embodiments provided in accordance with the presently disclosed subject matter include, but are not limited to, the following:

1. A fluid delivery device, comprising: a plate comprising a plate opening; a top wall, wherein the top wall and the plate cooperatively enclose a top chamber; a bottom wall, wherein the bottom wall and the plate cooperatively enclose a bottom chamber; a drain port communicating with the bottom chamber; and a pressure equilibration channel comprising a top channel opening communicating with the top chamber and a bottom channel opening communicating with the bottom chamber, wherein: the plate is configured to hold a compartment in the plate opening, such that a compartment inlet of the compartment communicates with the top chamber and a compartment outlet of the compartment communicates with the bottom chamber; and the fluid delivery device defines: a liquid flow path running through the solid phase material and out from the compartment outlet, through the bottom chamber, and into the drain port; and a gas flow path running between the top chamber and the bottom chamber via the pressure equilibration channel.

2. The fluid delivery device of embodiment 1, further comprising the compartment, positioned in the plate opening.

3. The fluid delivery device of embodiment 2, wherein the compartment comprises a solid phase material positioned between the compartment inlet and the compartment outlet.

4. The fluid delivery device of embodiment 3, wherein the compartment comprises a frit, and the solid phase material is retained on or embedded with the frit.

5. The fluid delivery device of embodiment 3 or 4, wherein the solid phase material is selected from the group consisting of: a plurality of solid phase support elements packed together as a solid phase bed; a porous monolithic support; and a porous material embedded in a frit.

6. The fluid delivery device of embodiment 3 or 4, wherein the solid phase material comprises a plurality of solid phase support elements, and the solid phase support elements have a characteristic dimension in a range from 10 μm to 1000 μm.

7. The fluid delivery device of any of embodiments 3-6, wherein the solid phase material has a pore size in a range from 10 nm to 200 nm.

8. The fluid delivery device of any of embodiments 3-7, wherein the solid phase material is composed of a material selected from the group consisting of: controlled pore glass; porous silica; and polymer resin.

9. The fluid delivery device of any of the preceding embodiments, comprising a drain valve communicating with the drain port and configured for on/off flow control, or configured for both on/off flow control and variable flow rate control.

10. The fluid delivery device of any of the preceding embodiments, comprising a gas inlet port communicating with the top chamber.

11. The fluid delivery device of embodiment 10, comprising a pressure regulating device communicating with the gas inlet port.

12. The fluid delivery device of embodiment 10 or 11, comprising a gas inlet valve communicating with the gas inlet port and configured for on/off flow control, or configured for both on/off flow control and variable flow rate control.

13. The fluid delivery device of any of the preceding embodiments, wherein the plate opening is one of a plurality of plate openings, and the plate is configured to hold a plurality of compartments in the respective plate openings, such that respective compartment inlets of the compartments communicate with the top chamber and respective compartment outlets of the compartments communicate with the bottom chamber.

14. The fluid delivery device of embodiment 13, wherein the plate openings are sized and positioned such that, when the compartments are positioned in the plate openings, the compartment inlets are spaced from each other at a distance selected from the group consisting of: a distance in a range from 2 mm to 50 mm; a distance of 9.0 mm; a distance of 4.5 mm; and a distance of 2.25 mm.

15. The fluid delivery device of embodiment 13 or 14, comprising the plurality of compartments, positioned in the respective plate openings.

16. The fluid delivery device of any of embodiments 13-15, wherein: the plurality of plate openings comprises a plurality of plate opening groups, each plate opening group comprising one or more of the plate openings; and the bottom chamber comprises a plurality of sub-chambers, each sub-chamber separately communicating with a respective one of the plate opening groups.

17. The fluid delivery device of embodiment 16, wherein: the pressure equilibration channel is one of a plurality of pressure equilibration channels comprising respective top channel openings communicating with the top chamber and bottom channel openings; and each bottom channel opening separately communicates with a respective one of the sub-chambers.

18. The fluid delivery device of embodiment 16 or 17, wherein the drain port is one of a plurality of drain ports, each drain port separately communicating with a respective one of the sub-chambers.

19. The fluid delivery device of any of the preceding embodiments, wherein the pressure equilibration channel is one of a plurality of pressure equilibration channels comprising respective top channel openings communicating with the top chamber and bottom channel openings communicating with the bottom chamber.

20. A fluid delivery system, comprising: a fluid delivery device according to any of embodiments 1-19; and a pressure regulating device communicating with at least one of the top chamber or the bottom chamber, and configured to create a pressure differential between the top chamber and the bottom chamber.

21. The fluid delivery system of embodiment 20, comprising a gas inlet port communicating with the top chamber, wherein the pressure regulating device communicates with the top chamber via the gas inlet port.

22. The fluid delivery system of embodiment 20 or 21, wherein the pressure regulating device comprises a pressurized gas source.

23. The fluid delivery system of embodiment 22, wherein the pressurized gas source comprises a pressurized gas reservoir and a gas inlet valve.

24. The fluid delivery system of embodiment 22, wherein the pressurized gas source comprises a pump.

25. The fluid delivery system of any of embodiments 20-24, wherein the pressure regulating device comprises a pump communicating with the bottom chamber.

26. The fluid delivery system of any of embodiments 20-25, comprising a liquid dispensing device configured to dispense a liquid into the compartment.

27. The fluid delivery system of any of embodiments 20-26, comprising a controller configured to control the steps of: operating the pressure regulating device to create the pressure differential; continuing to operate the pressure regulating device for a pulse period effective for flowing a liquid along the liquid flow path such that the liquid wets the solid phase material; and after the pulse period, ceasing to operate the pressure regulating device.

28. A method for delivering fluids, the method comprising: providing a fluid delivery device according to any of the aspects or embodiments disclosed herein; dispensing a liquid into the compartment; operating a pressure regulating device to create a pressure differential between the top chamber and the bottom chamber; continuing to operate the pressure regulating device for a pulse period effective for flowing the liquid along the liquid flow path such that the liquid wets the solid phase material; after the pulse period, ceasing to operate the pressure regulating device; and after the ceasing, eliminating the pressure differential by allowing a gas to flow through the pressure equilibration channel, wherein the liquid ceases to flow through the solid phase material.

29. The method of embodiment 28, wherein the operating of the pressure regulating device comprises applying a positive pressure pulse to the top chamber.

30. The method of embodiment 28 or 29, wherein the operating of the pressure regulating device comprises opening a gas inlet valve to flow a pressurized gas from a pressurized gas reservoir, through the gas inlet valve, and into the top chamber.

31. The method of any of embodiments 28-30, wherein the operating of the pressure regulating device comprises operating a pump to pump pressurized gas into the top chamber.

32. The method of embodiment 28, wherein the operating of the pressure regulating device comprises applying a negative pressure pulse to the bottom chamber.

33. The method of any of embodiments 32, wherein the operating of the pressure regulating device comprises operating a pump communicating with the bottom chamber.

34. The method of any of embodiments 28-33, wherein the pressure differential is in a range from 0.1 psi to 50 psi.

35. The method of any of embodiments 28-34, wherein the liquid comprises a plurality of (bio)chemical reagents, and the flowing of the liquid promotes a (bio)chemical reaction involving the (bio)chemical reagents on the solid phase material.

36. The method of embodiment 35, wherein the (bio)chemical reaction comprises a (bio)chemical synthesis.

37. The method of embodiment 35, wherein the (bio)chemical synthesis produces nucleotides.

38. The method of any of embodiments 35-37, wherein the (bio)chemical reaction occurs during a reaction period, and the reaction period is longer than the pulse period.

39. A non-transitory computer-readable medium, comprising instructions stored thereon, that when executed on a processor, control or perform one or more of the steps of any of embodiments 28-38.

40. A fluid delivery system, comprising the non-transitory computer-readable medium of embodiment 39.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the controller 874 schematically depicted in FIG. 8. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), or field-programmable gate arrays (FPGAs). Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the controller 874 schematically depicted in FIG. 8), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It will also be understood that the term “in signal communication” or “in electrical communication” as used herein means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

More generally, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A fluid delivery device, comprising:
a plate comprising a plate opening;
a top wall, wherein the top wall and the plate cooperatively enclose a top chamber;
a bottom wall, wherein the bottom wall and the plate cooperatively enclose a bottom chamber;
a drain port communicating with the bottom chamber; and
a pressure equilibration channel comprising a top channel opening communicating with the top chamber and a bottom channel opening communicating with the bottom chamber, wherein:
the plate is configured to hold a compartment in the plate opening, such that a compartment inlet of the compartment communicates with the top chamber and a compartment outlet of the compartment communicates with the bottom chamber; and
the fluid delivery device defines:
a liquid flow path running through the solid phase material and out from the compartment outlet, through the bottom chamber, and into the drain port; and
a gas flow path running between the top chamber and the bottom chamber via the pressure equilibration channel.

2. The fluid delivery device of claim 1, further comprising the compartment, positioned in the plate opening.

3. The fluid delivery device of claim 2, wherein the compartment comprises a solid phase material positioned between the compartment inlet and the compartment outlet.

4. The fluid delivery device of claim 3, wherein the compartment comprises a frit, and the solid phase material is retained on or embedded with the frit.

5. The fluid delivery device of claim 3, wherein the solid phase material is selected from the group consisting of: a plurality of solid phase support elements packed together as a solid phase bed; a porous monolithic support; and a porous material embedded in a frit.

6. The fluid delivery device of claim 3, wherein the solid phase material comprises at least one of the following features:
the solid phase material comprises a plurality of solid phase support elements, and the solid phase support elements have a characteristic dimension in a range from 10 μm to 1000 μm;
the solid phase material has a pore size in a range from 10 nm to 500 nm;
the solid phase material is composed of a material selected from the group consisting of: controlled pore glass; porous silica; and polymer resin.

7. The fluid delivery device of claim 1, comprising a drain valve communicating with the drain port and configured for on/off flow control, or configured for both on/off flow control and variable flow rate control.

8. The fluid delivery device of claim 1, comprising a gas inlet port communicating with the top chamber.

9. The fluid delivery device of claim 8, comprising a pressure regulating device communicating with the gas inlet port.

10. The fluid delivery device of claim 8, comprising a gas inlet valve communicating with the gas inlet port and configured for on/off flow control, or configured for both on/off flow control and variable flow rate control.

11. The fluid delivery device of claim 1, wherein the plate opening is one of a plurality of plate openings, and the plate is configured to hold a plurality of compartments in the respective plate openings, such that respective compartment inlets of the compartments communicate with the top chamber and respective compartment outlets of the compartments communicate with the bottom chamber.

12. The fluid delivery device of claim 11, wherein the plate openings are sized and positioned such that, when the compartments are positioned in the plate openings, the compartment inlets are spaced from each other at a distance selected from the group consisting of: a distance in a range from 2 mm to 50 mm; a distance of 9.0 mm; a distance of 4.5 mm; and a distance of 2.25 mm.

13. The fluid delivery device of claim 11, comprising the plurality of compartments, positioned in the respective plate openings.

14. The fluid delivery device of claim 11, wherein:
the plurality of plate openings comprises a plurality of plate opening groups, each plate opening group comprising one or more of the plate openings; and
the bottom chamber comprises a plurality of sub-chambers, each sub-chamber separately communicating with a respective one of the plate opening groups.

15. The fluid delivery device of claim 14, wherein:
the pressure equilibration channel is one of a plurality of pressure equilibration channels comprising respective top channel openings communicating with the top chamber and bottom channel openings; and
each bottom channel opening separately communicates with a respective one of the sub-chambers.

16. The fluid delivery device of claim 14, wherein the drain port is one of a plurality of drain ports, each drain port separately communicating with a respective one of the sub-chambers.

17. The fluid delivery device of claim 1, wherein the pressure equilibration channel is one of a plurality of pressure equilibration channels comprising respective top channel openings communicating with the top chamber and bottom channel openings communicating with the bottom chamber.

18. A fluid delivery system, comprising:
the fluid delivery device of claim 1; and
a pressure regulating device communicating with at least one of the top chamber or the bottom chamber, and configured to create a pressure differential between the top chamber and the bottom chamber.

19. The fluid delivery system of claim 18, comprising a controller configured to control the steps of:
operating the pressure regulating device to create the pressure differential;
continuing to operate the pressure regulating device for a pulse period effective for flowing a liquid along the liquid flow path such that the liquid wets the solid phase material; and
after the pulse period, ceasing to operate the pressure regulating device.

20. A method for delivering fluids, the method comprising:
providing the fluid delivery device of claim 1;
dispensing a liquid into the compartment;
operating a pressure regulating device to create a pressure differential between the top chamber and the bottom chamber;
continuing to operate the pressure regulating device for a pulse period effective for flowing the liquid along the liquid flow path such that the liquid wets the solid phase material;
after the pulse period, ceasing to operate the pressure regulating device; and
after the ceasing, eliminating the pressure differential by allowing a gas to flow through the pressure equilibration channel, wherein the liquid ceases to flow through the solid phase material.
